(19) United States
(12) Patent Application Publication
(10) Pub. No.: US 2002/0186742 A1
(43) Pub. Date: Dec. 12, 2002

(54) Single mode autocoupled resonator for telecommunications

(76) Inventors: Graham W. Flint, Albuquerque, NM (US); Maurice A. Pessot, San Diego, CA (US); Eugene R. Peressini, San Juan Capistrano, CA (US); Eric B. Takeuchi, San Diego, CA (US)

Correspondence Address: LAW OFFICES OF JAMES D. MCFARLAND, 12555 HIGH BLUFF DRIVE, SUITE 305, SAN DIEGO, CA, 92130, US

(21) Appl. No.: 10/138,079

(22) Filed: May 3, 2002

Related U.S. Application Data
(60) Provisional application No. 60/288,322, filed on May 3, 2001.

(51) Int. Cl. H01S 3/091; H01S 3/092; H01S 3/08

(52) U.S. Cl. 372/70; 372/108; 372/92

(57) ABSTRACT

A laser in which the laser emission is autocoupled into an optical fiber. The laser cavity is insensitive to misalignment; i.e. it will oscillate if the optical fiber is positioned within an allowed volume determined by a degenerate resonator configuration. In one embodiment, a solid state laser includes two ball lenses arranged on opposing sides of the gain medium. The degenerate resonator configuration is defined on one end by a reflectively-coated outer surface of the ball lens. The other end is approximately defined by an allowed volume on the outer surface of the second ball lens. To provide a laser cavity the reflective end of the optical fiber is situated within the allowed volume. The laser may be end-pumped using a fiber-coupled laser diode, and the ball lens is used to focus the pump beam into the gain medium. The reflective end may be provided by a Bragg grating.

### CROSS-REFERENCE TO RELATED APPLICATION

Priority is hereby claimed to U.S. application Ser. No. 60/288,322, filed May 3, 2001, entitled SINGLE MODE AUTOCOUPLED RESONATOR FOR TELECOMMUNICATIONS, which is incorporated by reference herein.

### BACKGROUND OF THE INVENTION

1. Field of the Invention

The present invention relates to lasers that are coupled to optical fibers.

2. Description of Related Art

Conventionally, optical couplers are used to couple a laser beam into an optical fiber. Optical couplers usually comprise a lens and a precision positioning apparatus. Coupling a laser beam into an optical fiber typically is achieved by way of a two-step process. First, the output beam from the laser device is brought to a focus, and then the point of focus and the core of the optical fiber are precisely moved into alignment.

It can be a difficult and time-consuming task to adequately align the focal point with the core, especially if the core diameter is small. For example, when the optical fiber is of the single mode variety (which is common in applications related to telecommunications and high-resolution imaging), the core of the fiber typically has a diameter that is less than ten times the output wavelength of the laser. In the case of 1550 nm lasers, which are used for telecommunications, common core diameters are around 10 microns.

For high-efficiency coupling, the relative positioning of the focused beam and the fiber core must exhibit a high precision, equivalent to a small fraction of the core diameter. For example in the case of a 10 micron core, positioning accuracy may be required to ±1 micron. Even a slight misalignment can drastically reduce coupling efficiency, and accordingly this precision alignment requires a skilled technician and a substantial amount of time, which can contribute significantly to the overall manufacturing cost. Furthermore, this high level of precision is difficult to maintain over any significant period of time, particularly in the presence of adverse environmental factors such as vibration, shock, and significant temperature excursions.

### SUMMARY OF THE INVENTION

A laser is described in which the reflective end of an optical fiber becomes an integral part of a resonator, and as a result the laser emission is autocoupled into an optical fiber. The laser cavity has reduced sensitivity to misalignment; it is designed to oscillate if the reflecting optical fiber is positioned within an allowed volume determined by a degenerate resonator configuration. In one embodiment, a Bragg grating within the core of an output fiber acts as an end reflector of the resonator. One advantage of such an embodiment is the ability to provide a predictable output wavelength by using a Bragg grating with the desired wavelength.

An autocoupled laser described herein comprises a solid state gain medium, an optical pump source arranged to pump the gain medium, an optical fiber having a reflective end, and a substantially degenerate resonator configuration that comprises a first end including a retro-reflector, a second end defined by an allowed volume, and wherein the reflective end of the optical fiber is situated within the allowed volume to define a laser cavity between the reflective end of the optical fiber and the retro-reflector.

Some embodiments comprise a first and second lens, such as a first ball lens situated between the gain medium and the retro-reflector. The first lens may have a reflective outer surface that defines the retro-reflector. The second lens may also be a ball lens

The autocoupled optical fiber may comprise a single mode fiber, which has a smaller core diameter than multi-mode fibers. To provide a reflective end, only the core may be reflectively coated. In some embodiments, the optical fiber comprises a Bragg grating inside the optical fiber, thereby providing the reflective end at the core. In other embodiments the reflective end comprises an exposed core and a reflective coating formed on the cladding of the optical fiber surrounding the core, so that laser emission within the laser cavity is hole-coupled into the core of the optical fiber.

The optical pump source may be arranged for end-pumping the solid state gain medium with optical pump radiation through the first ball lens. Furthermore, the optical pump source may comprise an optical pump fiber that delivers pump radiation from the source of laser radiation and emits it toward the first ball lens.

A laser assembly is disclosed that comprises first and second housings that respectively hold the first and second lenses and a fiber optic split sleeve that holds the first and second housings arranged with the gain block situated between the first and second housings. A first fiber optic coupler holds the optical pump fiber. A second fiber optic coupler holds the autocoupled optical fiber. A coupler housing connects the first and second fiber optic couplers, and situates the split sleeve between them in alignment so that the optical pump fiber is aligned with the first lens and the reflective end of the autocoupled fiber is aligned with the second lens. In some embodiments the first and second housings comprise press-fit housings for ball lenses.

In one embodiment, a solid state laser is described that includes two ball lenses arranged on opposing sides of the gain medium. The resonator configuration is defined on one end by a reflectively-coated outer surface of the ball lens. The other end is approximately defined by an allowed volume on the outer surface of the second ball lens. To provide a laser cavity the reflective end of the optical fiber is situated within the allowed volume. The laser is end-pumped using, for example a fiber-coupled laser diode, and the ball lens is used to focus the pump beam into the gain medium.

Advantages of some embodiments of the autocoupled laser described herein include its basic simplicity, its ease of assembly, its stability in the presence of environmental influences and its ability to provide an output frequency that is automatically selected by the optical characteristics of the fiber-optic coupler to which it is attached.

Due in part to the relaxed positioning requirements as compared with other lasers, it is believed that the autocoupled laser described herein can dramatically reduce the time and effort required for building such devices; thereby resulting in a drastic reduction in unit cost. In addition to cost benefits, it is believed that the laser will provide a substantial enhancement in device performance in terms of size, weight and ruggedness. Consequently, when implemented, the laser is believed not only to revolutionize the process by which lasers are manufactured, but also provide a large improvement in their performance-to-cost ratio.

### BRIEF DESCRIPTION OF THE DRAWINGS

For a more complete understanding of this invention, reference is now made to the following detailed description of the embodiments as illustrated in the accompanying drawing, wherein:

FIG. 1 is a schematic diagram that shows a conventional degenerate resonator that has retro-reflector arrangement;

FIG. 2 is a schematic diagram of a resonator configuration that is autocoupled into an optical fiber;

FIG. 3 is a schematic diagram of the configuration of FIG. 2 except that the optical fiber has been translated upwardly from the central axis;

FIG. 4 is a schematic diagram of the configuration of FIG. 2 except that the optical fiber has been translated downwardly from the central axis;

FIG. 5 is a schematic diagram of the second lens and the optical fiber arranged with respect to the central axis, illustrating permissible tilt of the reflective face of the optical fiber;

FIG. 6 is a cross-section of an embodiment of the optical fiber that includes a Bragg grating;

FIG. 7 is a cross-section of another embodiment of the optical fiber, including a reflective coating on the core;

FIG. 8 is a cross-section of another embodiment of the optical fiber, including a reflective coating on the cladding;

FIG. 9 is a perspective end view of the optical fiber embodiment of FIG. 8;

FIG. 10 is a schematic view of one embodiment of an autocoupled optically-pumped solid-state laser that includes ball lenses;

FIG. 11 is a diagram of the laser in FIG. 10 that shows the optical pump beam and the resonator mode, also showing a fiber-coupled laser diode pump source;

FIG. 12 is an end view of the second ball lens, illustrating an allowed volume for positioning the reflective end of the optical fiber;

FIG. 13 is a graph created by a computer model that shows the resonator mode waist at the fiber input plane as a function of the thermal lens focal length;

FIG. 14 is a graph created by a computer model that illustrates the change in resonator mode waist within the gain medium as a function of thermal lens focal length;

FIG. 15 is a graph created by a computer model that shows the distance between the pump fiber and the first ball lens as a function of pump focal length within the gain block;

FIG. 16 is an exploded perspective view of one implementation of an autocoupled laser;

FIG. 17 is an assembled perspective view of the implementation of the autocoupled laser as in FIG. 16;

FIG. 18 is a cross-sectional view of the implementation of the autocoupled laser as in FIG. 16; and

FIG. 19 is a cross-sectional view of a laser embodiment that utilizes a hole-coupled fiber as shown in FIG. 8.

### DETAILED DESCRIPTION

This invention is described in the following description with reference to the figures, in which like numbers represent the same or similar elements.

Glossary of Terms and Acronyms

The following terms and acronyms are used throughout the detailed description:

| | |
|---|---|
| DPSS laser | Diode-pumped solid state laser |
| Er | erbium |
| n | index of refraction |
| Yb | ytterbium |
| YVO₄ | yttrium orthovanadate (a birefringent material) |
| Er, Yb: glass | a co-doped, broadband solid state gain medium that has a |
| | gain-bandwidth of about 40 nm, centered at about |
| | 1550 nm |
| Degenerate | an optical cavity that allows a large number of |
| resonator | spatial modes |

Degenerate Resonator Example

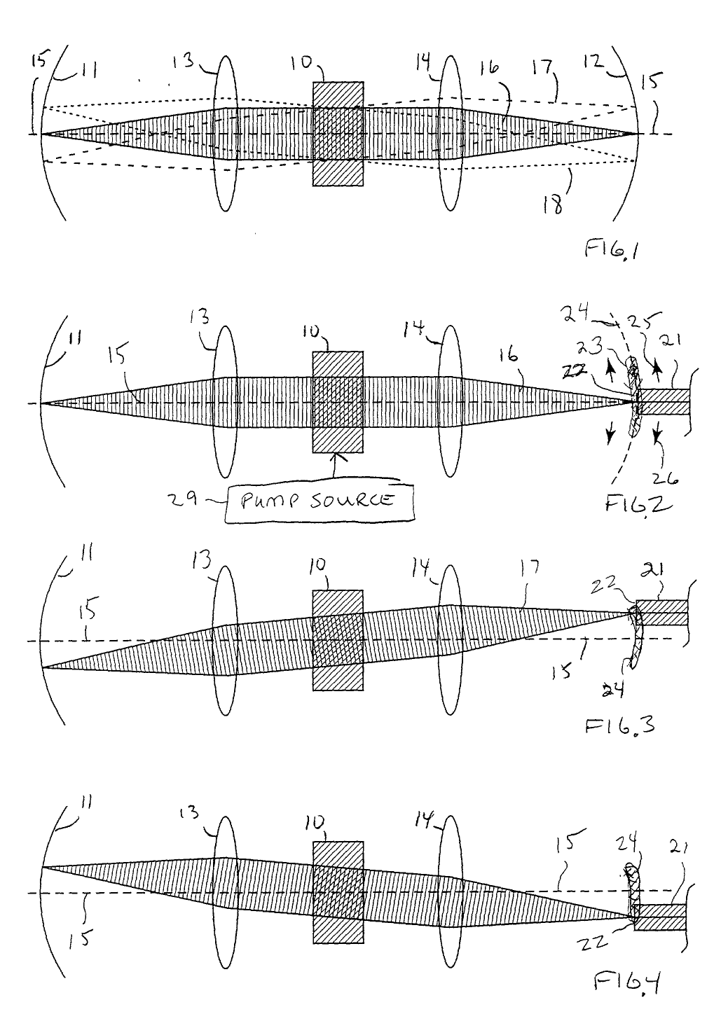

FIG. 1 is a schematic diagram that shows a conventional degenerate resonator that has a retro-reflector arrangement. In addition to this arrangement, numerous other optical geometries can provide a degenerate resonator.

In the retro-reflector arrangement of FIG. 1, a gain medium 10 is situated in a resonant cavity defined between a first end mirror 11 and a second end mirror 12, both of which have a similar concave configuration. A pair of positive lenses, including a first lens 13 and a second lens 14, are arranged such that their curved focal planes coincide with the surfaces of the proximate concave mirror. In other words, the first reflector has a curved shape that approximately matches the curved focal plane of the first lens 13, and the second reflector has a curved shape that approximately matches the curved focal plane of the second lens 14. The gain medium 10 is situated approximately midway between the first and second lens. Thus, a retro-reflector resonator configuration is created. Because of their retro-reflective nature, the alignment and positional tolerances associated with such lens/mirror combinations are much less strict as compared with those imposed upon the positioning of conventional (e.g. flat) end mirrors; i.e. this retro-reflector resonator configuration is much less sensitive to misalignment.

The resonator configuration defines a central axis 15, and the degenerate resonator arrangement permits laser oscillation along a large number of allowed spatial modes about this central axis 15. For example, FIG. 1 shows three allowed spatial modes: a first spatial mode 16 approximately aligned with the central axis 15, a second spatial mode 17 tilted counter-clockwise from the central axis, and a third spatial mode 18 tilted clockwise from the central axis. It should be apparent that a large number of allowed spatial modes exist between and around the first, second, and third spatial modes.

In FIG. 1, the relatively large area of the first and second reflectors allow numerous spatial modes. Because each of these spatial modes compete for the finite gain available in the gain medium, it is likely that much more than a single spatial mode will oscillate.

Autocoupled Laser Description

FIG. 2 is a schematic diagram of a resonator configuration that is autocoupled into an optical fiber 21 that comprises a reflective end 22 that defines one end of the laser cavity. In order to provide effective laser oscillation, the reflective end 22 is positioned within an allowed volume 23 that is determined by the resonator arrangement. In the retro-reflector embodiment, the allowed volume is situated proximate to a curved line 24 that approximately follows the shape of the second end mirror 12 shown in FIG. 1; in other words, the curved line 24 approximately follows the curved focal plane of the second lens 14. Due to the small size of the reflective end of the optical fiber, the number of allowed spatial modes are very limited in comparison to the double curved-mirror configuration of FIG. 1, and therefore only those spatial modes will likely have sufficient gain to oscillate.

The reflective end may be implemented in the optical fiber in a variety of configurations, such as discussed with reference to FIGS. 6, 7, 8, and 9. For example, in one embodiment the core of the optical fiber includes a Bragg grating that provides sufficient reflectivity to act as an end reflector of the resonator.

Because the laser has a degenerate resonator geometry, the coupling efficiency into the optical fiber 21 has a much reduced sensitivity to misalignment. The optical fiber 21 can translate some distance in either direction within the allowed volume 23, as shown by the upward arrow 25 and the downward arrow 26, and the laser will still operate efficiently. Particularly, as the optical fiber 21 moves upwardly or downwardly within the allowed volume 23, the spatial mode(s) in which lasing occurs will naturally and automatically move to coincide with the reflective end of the optical fiber.

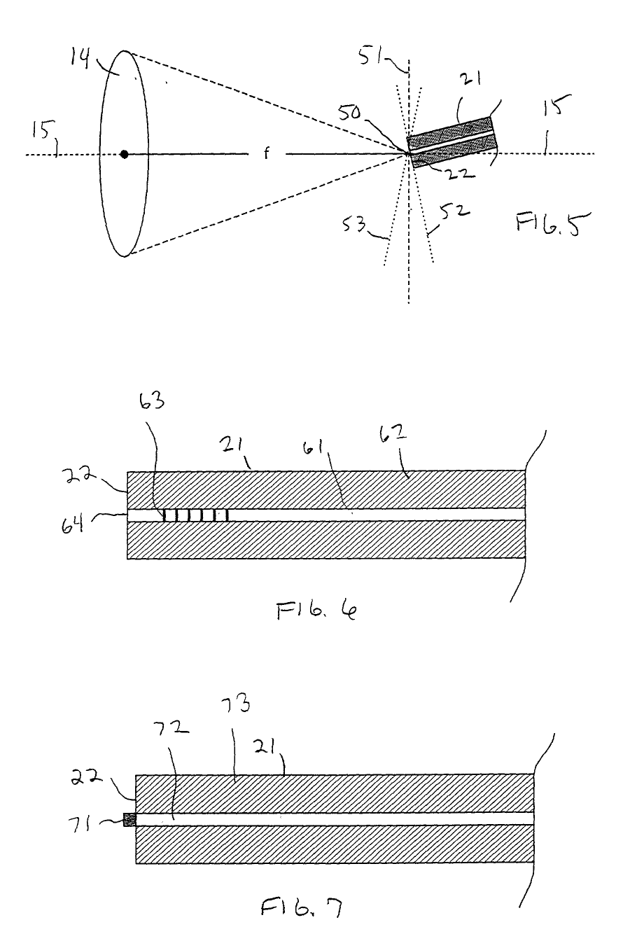

In FIG. 2 the optical fiber 21 is approximately centrally-positioned along the central axis, and accordingly the allowed spatial mode is the first spatial mode 16 (also shown in FIG. 1). FIG. 3 is a schematic diagram in which the optical fiber 21 has been translated upwardly from the central axis 15. As a result of this upward movement, the second mode 17, which is tilted counterclockwise from the first mode 16, will oscillate. For comparison, FIG. 4 is a schematic diagram in which the optical fiber 21 has been translated downwardly from the central axis 15. As a result of this downward movement, the third spatial mode 18, which is tilted clockwise from the first mode 16, will oscillate.

In summary, it can be seen from FIGS. 2, 3, and 4 that it is not necessary to precisely position the end of the optical fiber to achieve efficient coupling. Specifically, the reflective end of the optical fiber can be situated within the relatively larger allowed volume 23, as defined by the resonator configuration. When situated at any position within the allowed volume 24, the reflective end 22 will form one end of the laser cavity. Furthermore, the laser's output is coupled directly into the optical fiber automatically, without further positioning.

For purposes of illustration, FIG. 2 is drawn in a two-dimensional view. It should be apparent that this configuration is extendable to three dimensions by, for example rotating this configuration around the central axis 15. In other words, the laser will continue to oscillate even when the optical fiber is translated through translations in all three axes, as illustrated in two dimensions by the allowed volume 23 and arrows 25 and 26, which show allowed movement of the end of the optical fiber with respect to the central axis 15.

A pump source 29, shown in FIG. 2, is provided to pump the gain medium 10. For example, the laser may be implemented with a solid state gain medium that is optically pumped by a laser diode. Although the laser described herein can be implemented with a variety of gain media, in one embodiment the laser utilizes 1.5 μm laser technology and the gain medium 10 comprises a Er,Yb:glass gain medium that is optically pumped with a conventional broad-stripe diode laser that emits around 980 nm. Advantageously, Er,Yb:glass has a much broader gain bandwidth than typical crystalline laser gain media, allowing operation over a wavelength range consistent with that used in current optical communications systems. In the co-doped Er,Yb:glass system, the Yb ions efficiently absorb pump radiation at 980 nm, and transfer their energy to the Er ions which lase around 1.5 μm. When implemented within the degenerate resonator described herein, this gain medium can provide stable, high power (e.g. >100 mW) single frequency output into a single mode fiber in some embodiments.

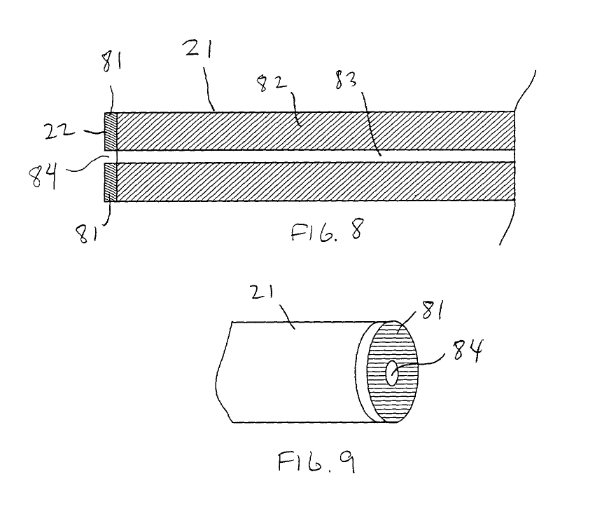

Reference is now made to FIG. 5, which is a schematic diagram of the second lens 14 and the optical fiber 21 arranged with respect to the central axis 15. The lens 14 defines a focal distance f and a focal point 50. A normal line 51 is defined perpendicular to the central axis 15. In FIG. 5, the reflective face 22 is tilted to follow a reference line 52 that defines a permissible tilt angle φ with respect to the normal line 51. In the retro-reflector arrangement the permissible tilt of the reflective end with respect to the central axis of the resonator is relatively large because the core of the optical fiber is situated proximate to the focal point of the second lens and therefore the diameter of the reflective end of the optical fiber is matched to a diffraction-limited beam waist. As a result, rotation of the reflective surface about the central axis 15 has reduced adverse effect. It may be noted that tilting in the opposite direction from reference line 52 is equally permissible, and therefore if the reflective face were tilted in the opposite direction to follow the reference line 53 at an angle φ, then this would also be permissible.

Thus, the small reflective end of the optical fiber can undergo excursions in all six degrees of freedom (three translational axes and three tilt axes) without adversely affecting resonator performance.

Reflective End of Optical Fiber

Reference is now made to FIGS. 6, 7, 8, and 9. To create an autocoupled device as described herein, the end of the optical fiber exhibits a reflectivity that supports laser action. Reflectivity can be implemented in a number of ways such as a reflective coating, a Bragg grating or a reflective coating that leaves the core exposed.

FIG. 6 is a cross-section of one embodiment of the optical fiber 21 that includes a core 61 and a cladding 62. A Bragg grating 63 is incorporated within the core of the fiber. One advantage of using the Bragg grating is that the amount of reflectivity of the grating can be chosen so as to provide a desired output coupling, which can be used to optimize output power and efficiency. Another advantage of a Bragg grating is that it permits selection of the frequency at which the resonator oscillates. Particularly in the case of lasers that utilize broadband erbium-based gain media, which operate at wavelengths in the vicinity of 1550 nm, the ability to select the frequency becomes a highly useful feature. Because the Bragg grating is within the core, it may be noted that the apparent reflectance provided by the end of the optical fiber is limited to the entrance area 64 of the core, which advantageously limits reflectance to a smaller area than the entire face of the optical fiber.

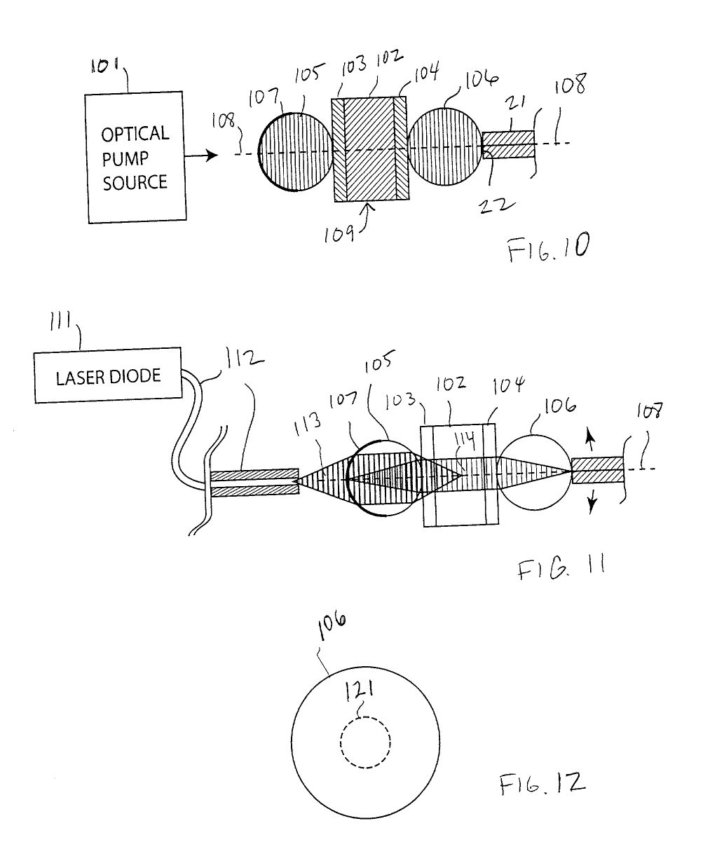

FIG. 7 is a cross-section of an alternative embodiment in which a reflective coating 71 is formed substantially on the entrance of the core 72, substantially avoiding the surrounding cladding 73. Use of a Bragg grating is believed to be preferable to the use of a reflective coating upon the entrance face of the core for several reasons. First, because of the small diameter of the fiber core, it likely would be difficult to confine a multi-layer dielectric coating to the core alone. If not confined to the core, a portion of the output of the resonator output power would be coupled into the cladding of the fiber; a circumstance which is, at best, a waste of output power. Second, the Fourier transform of a hard-edged aperture (such as that presented by the coated core) is less well matched to the power distribution within the gain region of a resonator than the transform of a soft-edged fiber core.

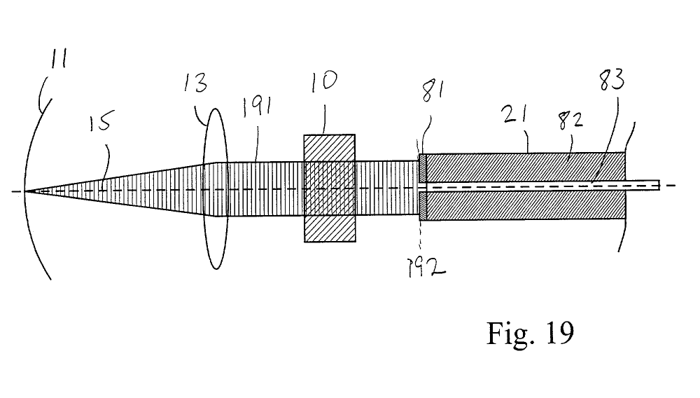

FIG. 8 is a cross section of a “hole-coupled” fiber embodiment of the optical fiber 21, which has a reflective coating 81 formed thereon in a donut configuration, leaving the core exposed. FIG. 9 is a perspective view of the end of this embodiment of optical fiber. In this embodiment, the reflective coating 81 is formed as a total reflector, to cover the end of the cladding 82, but not the entrance to the core 83. Particularly, the reflective coating is formed with a center hole to leave the entrance 84 exposed. In operation, laser oscillation is provided between the reflective portion of the cladding and the opposite end mirror. Some amount of the laser oscillation leaks through the center hole and is coupled through the entrance 84 into the optical fiber. As will be discussed with reference to FIG. 19, when a hole-coupled fiber is used, the resonator design may be modified; for example, the second lens may be modified or omitted entirely, and the fiber is placed at a location where the mode size is comparable to (but typically smaller) than the full diameter of the optical fiber end. This configuration is believed to provide a large tolerance to translational (x-y-z) misalignments of the optical fiber face with respect to the mode diameter, but may provide more sensitivity to angular misalignments of the reflective face to the mode.

Solid State Laser Embodiment with Ball Lenses

FIG. 10 is a schematic view of one embodiment of an autocoupled optically-pumped solid-state laser that can be used for example for telecommunications applications. A suitable optical pump source 101, such as a laser diode, supplies optical pump energy to end-pump the laser assembly. A gain medium 102 is situated between a first and a second slabs 103 and 104 that comprise a transparent material for cooling the gain medium 102. Collectively, the gain medium, and the first and second slabs define a gain block 109.

A first ball lens 105, which operates as both a retro-reflector and a focusing lens, is situated proximate to the first slab 103. A second ball lens 106, which operates as a focusing lens, is situated proximate to the second slab 104. The first ball lens includes a coating 107 on its outer surface that is highly reflective to the laser emission, but substantially transmissive to the optical pump radiation from the pump source 101. The reflective end of the optical fiber is positioned proximate to the outer surface of the second ball lens, within an allowed volume (FIG. 12) from the central axis as determined by the resonator configuration.

A degenerate cavity geometry with a central axis 108 is defined between the coating 107 on the first ball lens 105 and the outer surface of the second ball lens 106. However, the outer surface of the second ball lens is not reflective at the laser emission wavelength, and therefore by itself it cannot operate as one of the end mirrors. The reflective face 22 of the optical fiber 21 is situated proximate to the outer surface of the second ball lens, and within a distance from the central axis 108 (an allowed volume as in FIG. 12) that will allow efficient lasing. As described with reference to FIGS. 2, 3, 4, and 5, for example, because the reflective end of the optical fiber defines the spatial modes that will oscillate, it is not necessary to precisely position the end of the optical fiber to achieve efficient coupling into the optical fiber 21. Specifically, the reflective end of the optical fiber can be situated within a relatively larger allowed volume, as defined by the resonator configuration. Furthermore, the laser's output is coupled directly into the optical fiber automatically, without further positioning.

FIG. 11 is an example of an embodiment of the laser in FIG. 10, showing a laser diode 111 that is coupled via an optical fiber 112 to pump the laser assembly. FIG. 11 shows the pump beam 113 exiting the optical fiber 112, propagating through the coating 107, and being focused by the first ball lens 105 into the gain medium 102. As a result of sufficient pumping, a laser oscillation 114 is created between the coating 107 on the first ball lens and the reflective end 22 of the optical fiber 21. Thus, FIG. 11 shows simultaneous use of the first ball lens 107 as one of the end mirrors and also as a means for focusing pump radiation into the gain volume of the resonator.

In one embodiment the pump radiation from the laser diode 111 may emanate from the end of an approximately 150-micron fiber. Such an arrangement is advantageous insofar as the fiber end provides a uniformly circular source, which in turn provides a rotationally symmetric gain region, together with rotationally symmetric thermal lensing. However, alternative embodiments could comprise one or more lenses that refocus the pump radiation directly from the pump source without benefit of a fiber. Nevertheless, to preserve device efficiency in one embodiment, the first ball lens 105 exhibits high transmittance at the pump wavelength. Hence, the surface of the first ball lens adjacent to the gain block is antireflection coated for both pump and oscillator wavelengths. Meanwhile, the other surface of the first ball lens, proximate to the pump source, combines a high reflectance at the oscillator wavelength with a low reflectance at the pump wavelength. Both surfaces of the second ball lens 106, and the outer surfaces of the first and second slabs 103 and 104 are provided with antireflection coatings for the laser emission wavelength, the spectral coverage of the coatings being sufficient to encompass the range of wavelengths over which the device is expected to oscillate. The outer surface of the first slab 103 is also AR-coated for the pump wavelength, the other surfaces may also be AR-coated for the pump wavelength.

One problem associated with telecommunications applications is the small physical size of component parts and of the attendant difficulties associated with assembling those parts into a device that will operate reliably in the field. For example in one embodiment the gain medium 102 may comprise a small cylindrical volume having a length along the central axis of about 1000 microns (1 mm). In this embodiment, the two thin slabs 103 and 104 of transparent material may be attached to the end faces of the gain volume, which serve to provide face cooling of the gain medium. As each of the thin slabs 103 and 104 has a thickness of about 250 microns, the total length of the gain-producing element is approximately 1.5 millimeters in one embodiment.

One advantage of using the first and second ball lenses is that they can be manufactured at suitably small dimensions for retro-reflectors (e.g. in the sub-millimeter regime). For example, it may be desirable one or both of the ball lenses to have a radius of between 350 and 450 microns. Furthermore, when comparing the embodiment of FIGS. 10 and 11 with FIGS. 2, 3, 4, and 5, it is apparent that the ball lenses serve a dual function: they operate as the retro-reflectors and also as lenses; thereby simplifying construction and reducing costs. Although the diameters of the first and second ball lenses are equal in some embodiments, in alternative embodiments the diameters of the two balls need not necessarily be equal. Furthermore, although the refractive indices of the two ball lenses are equal in some embodiments, in other embodiments the two balls have different refractive indices. Collectively, this combination of circumstances permits a great deal of resonator design flexibility.

In some embodiments, the absorption of pump radiation introduces a negligible amount of thermal lensing within the gain block; the gain block being defined as the gain medium itself, together with its flanking heat spreaders. In the absence of thermal lensing, the ball lenses will act as retro-reflectors with respect to collimated radiation. For the numerical apertures of interest, this condition is satisfied when the refractive index of the balls is 2.0 and the rear surfaces of the lenses are coated for high reflectance. However in other embodiments, thermal lensing due to pump absorption is non-negligible. Hence, the effective focal length of each ball lens must be made somewhat greater than its diameter. This situation can be accommodated by the use of lenses having refractive indices slightly less than 2.0. It is believed that undoped YAG (with a refractive index of approximately 1.81) constitutes a highly suitable choice of material to accommodate thermal lensing problems in some embodiments.

To achieve autocoupling into a single-mode fiber, one end mirror is provided by the high reflectance coating 107 on the first ball lens 105; and the opposite end mirror is provided by the reflective properties of a Bragg-grating-equipped fiber, which provides the equivalent of a small circular mirror coincident with the rear surface of the right-hand ball. In this manner, the degeneracy of the resonator is broken by confining oscillation to only that mode which is efficiently coupled into the fiber.

Selection of the specific wavelength of oscillation can be effected by choosing the spectral reflectance of the Bragg grating within the optical fiber 21. This intrinsic feature of an autocoupled device permits one to design a generic resonator that automatically adjusts its output wavelength so as to exactly match the specific wavelength selected by the optical fiber to which it is coupled. Furthermore, in some embodiments, in addition to a Bragg-grating the optical fiber 21 can also include a piezoelectric element that provides wavelength tuning, and in such embodiments the output wavelength of the resonator can be made to track that wavelength in a precise fashion.

Reference is now made to FIG. 12, which is an end view of the second ball lens 106, illustrating an allowed volume at 121. Note that, for such a geometry, small translations and tilts of the fiber merely induce small angular shifts in the modes which can oscillate; thereby creating a situation in which efficient coupling into the fiber is preserved, provided only that displacements of the fiber end are within the allowed volume 121. In one example the allowed volume 121 may be equivalent to several diameters of the fiber core, rather than the much smaller, fractional core diameter tolerances that would be required in conventional fiber couplers.

Example: Computer Modeling Results

Given a device geometry as in FIG. 11 a computer model has been developed to predict performance. In this example, the gain block 109 is assumed to have a thickness of about 1.5 mm with a gain medium of Er,YB:glass, the first and second ball lenses have an equal diameter and an index of refraction of about 1.81, the pump fiber 112 is a multi-mode fiber with a 150 micron diameter, and the output fiber 21 is a single mode fiber with a Bragg grating and a 10.5 micron core diameter.

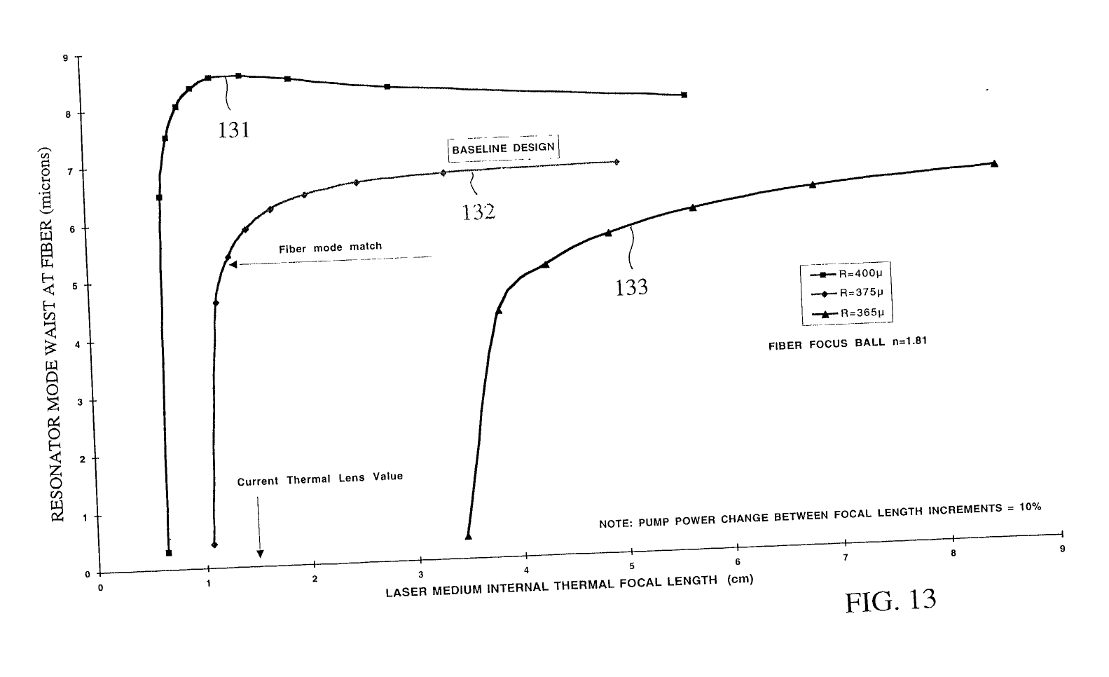

FIG. 13 is a graph that shows the resonator mode waist at the fiber input plane as a function of the thermal lens focal length. The three curves correspond to three different radii of the ball lenses: a first curve 131 shows a radius of 400 microns, a second curve 132 shows a radius of 375 microns, and a third curve 133 shows a radius of 365 microns. Each focal length is derived from the absorbed pump power delivered by the 150 μm pump diode fiber. The index for the ball lenses was chosen to be 1.81 (e.g. clear YAG). The thermal lens focal length was estimated to be approximately 15 mm. From FIG. 13 it can be seen that, for this focal length, a ball lens with radius 375 μm is required to produce a mode match with standard single-mode fiber. Because of the steepness of the curve in this region, it is anticipated that the efficiency of the system may be sensitive to pump power fluctuations. However, if the optical efficiency of the laser is improved over the assumed value, this curve will move to the right where ball lenses of shorter radii can be used. This, in turn, decreases the thermal sensitivity of the device.

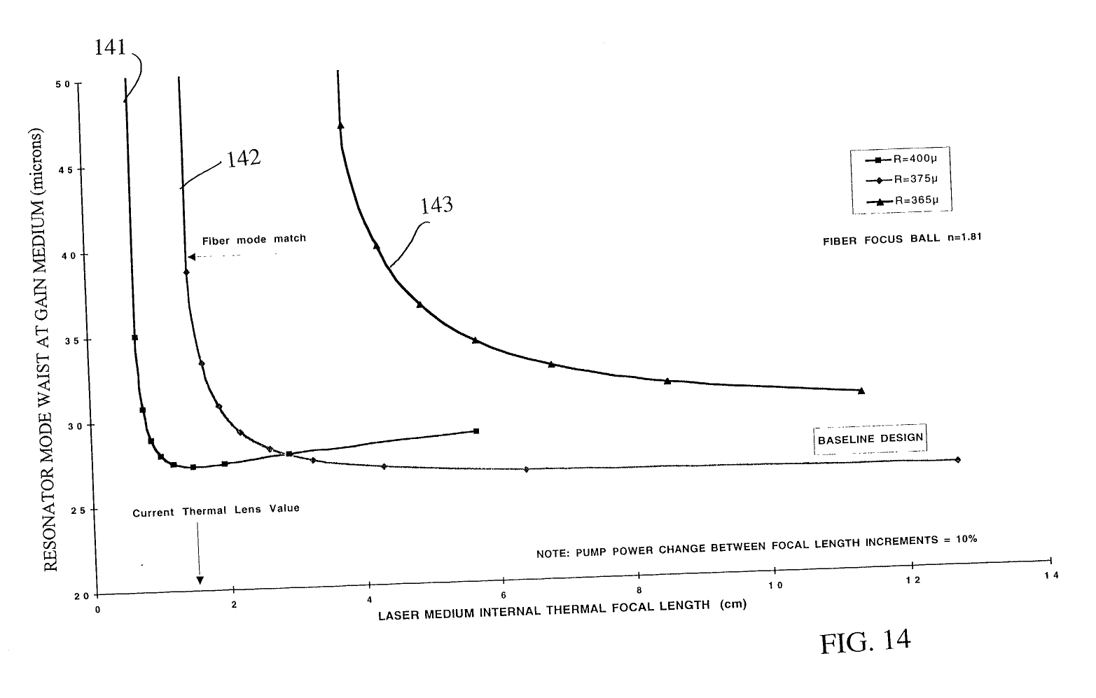

FIG. 14 is a graph that illustrates the change in resonator mode waist within the gain medium as a function of thermal lens focal length. The three curves correspond to results for three different radii of the ball lenses: a first curve 141 shows a radius of 400 microns, a second curve 142 shows a radius of 375 microns, and a third curve 133 shows a radius of 365 microns. For the region that corresponds to the optimum waist at the fiber, the mode waist in the gain medium is well matched to that of the pump, which corresponds to efficient operation.

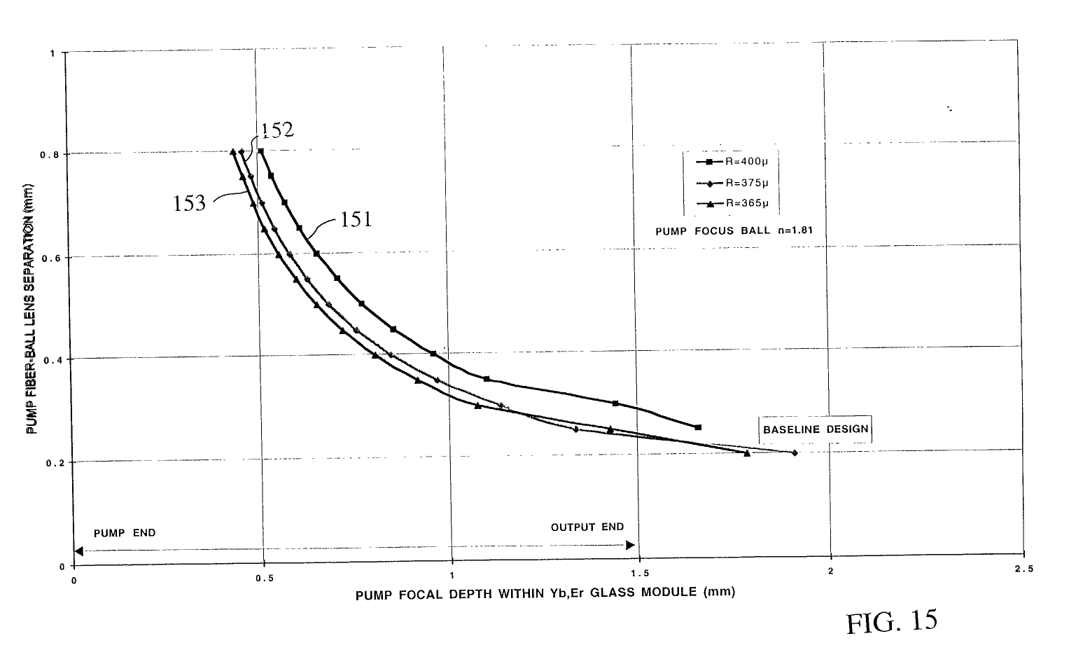

FIG. 15 is a graph that shows the requisite distance between the pump fiber and the first ball lens as a function of pump focal depth within the gain block. The three curves correspond to results for three different radii of the ball lenses: a first curve 151 shows a radius of 400 microns, a second curve 152 shows a radius of 375 microns, and a third curve 153 shows a radius of 365 microns. For a focal depth corresponding to a reasonable thickness of gain material (about 1 mm), the separation between fiber and ball lens becomes a few hundred microns; i.e. corresponds to a distance which is relatively insensitive to the pump focal depth within the gain medium.

Implementation Examples

The autocoupled laser described herein can be implemented in a variety of embodiments. For example, it can be implemented to take advantage of a number of manufacturing technologies such as the “slice and dice” techniques for fabrication of raw materials. Of particular significance is the self-aligning feature of the laser; a feature that allows assembly tolerances to be significantly relaxed and, in turn, allows for the labor required for assembly to be reduced.

For example, each of the individual components (ball lenses, gain block, and so forth) can be mounted into a single base fixture onto which all the components are mounted. This can be accomplished in a number of ways. In some embodiments, given the cylindrical geometry of each of the components, mounting fixtures can be made to allow for light-press-fit assembly. In such embodiments, each of the mounting holes within the integrated structure is made slightly less than the diameter of the component so that once the component is pressed into the housing, it remains held in place due to the elastic forces imparted by the mount. In other embodiments it also may be possible to metalize a portion of the surface of each of the components; thereby allowing laser welding procedures to be implemented. Each of these methods advantageously avoids the use of epoxies, which can be useful because epoxies typically exhibit problems such as outgassing, environmental instability, long cure times, and shrinkage. However, despite these potential problems, epoxies may still be used in some embodiments.

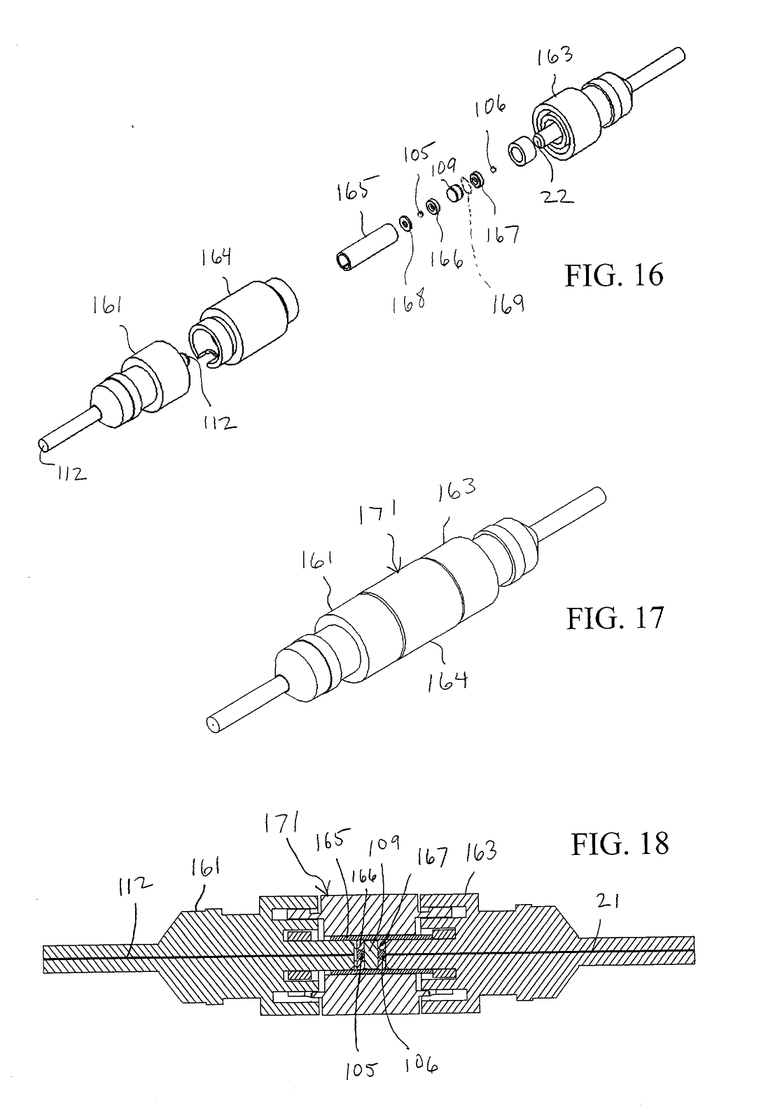

In some embodiments, each individual mount can be fabricated using single-point diamond machining techniques, allowing for flat and parallel surfaces to be applied to the mounts. It is believed that single-point machining techniques can provide “snap together” designs that require no subsequent alignment. Generally, the combination of relaxed alignment tolerances (which result from the resonator design), together with the fabrication capabilities provided by conventional precision machining techniques, allows for the simplified, drop-in assembly techniques, one example of which is shown in FIGS. 16, 17, and 18.

Reference is now made to FIGS. 16, 17, and 18 to illustrate one implementation of an autocoupled laser in a package that facilitates low-cost manufacturing techniques with a potentially high yield. FIG. 16 is an exploded perspective view, FIG. 17 is an assembled perspective view, and FIG. 18 is a cross-sectional view of this implementation. Using standard fiber-optic connectors made to precision tolerances, the pump and output fibers are provided to the device; particularly a first fiber-optic coupler 161 is used to couple the pump fiber 112, and a second fiber-optic coupler 163 is used to couple the single mode optical fiber 21 that has the reflective end 22 that will define one end of the laser cavity. A coupler housing 164 includes a section on one end for attaching the first fiber optic coupler 161, another section on the other end for attaching the second fiber optic coupler 163. The center of the coupler housing 164 includes a cylindrical opening to hold a fiber optic split sleeve 165. The fiber optic split sleeve 165 is a cylindrical tube with a lengthwise split, and is used to house and align optical components.

For insertion into the split sleeve 165, the gain block 106 may have a cylindrical configuration that allows it to slide into position within the split sleeve. First and second press-fit housings 166 and 167 have an outer cylindrical diameter that allows them to slide into the split sleeve 165. The inner section of the first press-fit housing 166 has a shape for receiving the first ball lens 105, and similarly, the inner section of the second press-fit housing 167 has a shape for receiving the second ball lens 106.

To assemble the laser in this implementation, the first and second ball lenses 105 and 106 are pressed into their respective mounts 166 and 167. Then the optical components (and any other spacers or optical devices that may be useful) are inserted into the split sleeve 165 so that the gain block 109 is situated between the two mounted ball lenses. In this embodiment, a spacer 168 is inserted between the first press-fit mount 166 and the end of the optical pump fiber 112. In alternative embodiments, other spacers, and other optical devices such as shown at 169 may be inserted. In the assembled structure, shown at 171, (FIGS. 17 and 18) the split sleeve 165 is situated within the coupler housing 164. The first and second fiber-optic couplers 161 and 163 are situated, respectively, at opposite ends of the split sleeve 165 so that the ends of the respective optical fibers are optically coupled with their respective ball lenses. Typically, the fiber optic couplers are tightened onto the coupler housing, such as by a threaded arrangement. The structure of the coupler housing, in conjunction with the first and second fiber-optic couplers and the split sleeve is such that the optical pump fiber 112 is aligned with the first ball lens, and the reflective end of the optical fiber 21 is aligned with the second ball lens. It is believed that the final average assembly time for producing lasers of this type will be significantly reduced (e.g. from days to minutes) while, at the same time, production yields should be superior to those typical of conventional DPSS lasers.

It may be noted that additional optical elements such as shown as 169 can be straightforwardly be added to the laser assembly show in FIGS. 16, 17, and 18. For example it is easy to add one or more optical elements between the ball lenses, such as non-linear crystals and saturable absorbers.

FIG. 19 is a cross-section of an embodiment that uses a hole-coupled fiber situated within a resonator. In this embodiment, a single lens 13 is situated in the resonator with the gain medium 10. The retroreflector 11 provides one end of the laser cavity, and the reflective end 81 of the optical fiber provides the other end. Comparing FIG. 19 with FIG. 2, it can be seen that the second lens is omitted entirely in this embodiment. The resonator creates a mode 191, and the reflective fiber end is situated at a location 192 where the mode size is comparable to (but typically smaller) than the full diameter of the optical fiber end. This configuration is believed to provide a large tolerance to translational (x-y-z) misalignments of the optical fiber face with respect to the mode diameter, but may provide more sensitivity to angular misalignments of the reflective face to the mode. In other embodiments, the lens 13 may comprise a ball lens, and in some embodiments the ball lens may comprise a reflective outer surface that defines the retroreflector.

It will be appreciated by those skilled in the art, in view of these teachings, that alternative embodiments may be implemented without deviating from the spirit or scope of the invention. This invention is to be limited only by the following claims, which include all such embodiments and modifications when viewed in conjunction with the above specification and accompanying drawings.

What is claimed is:

1. An autocoupled laser comprising:
a solid state gain medium;
an optical pump source arranged to pump said gain medium;
an optical fiber having a reflective end; and
a substantially degenerate resonator configuration comprising
a first end including a retro-reflector, and
a second end defined by an allowed volume,
wherein said reflective end of said optical fiber is situated within said allowed volume to define a laser cavity between said reflective end of said optical fiber and said retro-reflector.

2. The laser of claim 1 wherein said optical fiber comprises a single mode fiber.

3. The laser of claim 1 further comprising an optical pump fiber coupled to said pump source to supply optical pump radiation to said gain medium.

4. The laser of claim 1 further comprising a first lens situated between said gain medium and said retro-reflector, said first lens comprising a reflective coating that defines said retro-reflector.

5. The laser of claim 4 further wherein said first lens comprises a first ball lens, and further comprising a second ball lens situated between said gain medium and said optical fiber, said second ball lens being AR-coated.

6. The laser of claim 1 wherein said laser cavity defines a resonant mode, and said optical fiber has a core and a cladding surrounding the core, said reflective end comprises an exposed core and a reflective coating formed on the cladding of said optical fiber surrounding said core, and the reflective end of the optical fiber is situated within the laser cavity at a position where the mode has a diameter approximately equal to or less than the diameter of the optical fiber, so that laser emission within said laser cavity is hole-coupled into said core of said optical fiber.

7. The laser of claim 1 wherein said optical fiber comprises a Bragg grating inside said optical fiber, thereby providing said reflective end.

8. An autocoupled laser comprising:
a first lens and a second lens;
a gain medium situated between said first and second lenses;
an optical fiber that has a reflective end; and
a laser cavity comprising a first end that comprises a retro-reflector and a second end that comprises said reflective end of said optical fiber.

9. The laser of claim 8 wherein said optical fiber comprises a single mode fiber.

10. The laser of claim 8 wherein said retro-reflector comprises a reflective surface formed on said first lens.

11. The laser of claim 8 wherein said gain medium comprises a solid state gain medium and means for optically pumping said solid state gain medium.

12. The laser of claim 8 wherein said optical fiber comprises a Bragg grating inside said optical fiber, thereby providing said reflective end.

13. The laser of claim 8 wherein said optical fiber has a core and a cladding surrounding the core, and said reflective end comprises an exposed core and a reflective coating formed on the cladding of said optical fiber surrounding said core, so that laser emission within said laser cavity is hole-coupled into said core of said optical fiber.

14. The laser of claim 8 wherein said retro-reflector comprises a concave mirror situated at the curved focal plane defined by said first lens.

15. The laser of claim 8 wherein said first lens comprises a first ball lens, said second lens comprises a second ball lens, and wherein said retro-reflector is formed by a reflectively-coated surface of said first ball lens.

16. An autocoupled laser comprising:
a first ball lens that comprises a reflective outer surface;
a second ball lens;
a solid state gain medium situated between said first and second ball lenses;
an optical fiber that has a reflective end; and
a laser cavity comprising
a first end defined by said reflective surface of said first ball lens, and
a second end defined by said reflective end of said optical fiber.

17. The laser of claim 16 wherein said optical fiber comprises a Bragg grating inside said optical fiber, thereby providing said reflective end.

18. The laser of claim 16 wherein said optical fiber has a core and a cladding surrounding the core, and said reflective end comprises an exposed core and a reflective coating formed on the cladding of said optical fiber surrounding said core, so that laser emission within said laser cavity is hole-coupled into said core of said optical fiber.

19. The laser of claim 16 wherein said optical fiber comprises a single mode optical fiber.

20. The laser of claim 16 wherein said gain medium comprises Er,YB:glass.

21. The laser of claim 16 further comprising an optical pump source for end-pumping said solid state gain medium with optical pump radiation through said first ball lens.

22. The laser of claim 21 wherein said optical pump source comprises an optical pump fiber coupled to a source of optical radiation.

23. The laser of claim 22 further comprising a laser assembly that comprises:
a first housing that holds said first ball lens;
a second housing that holds said second ball lens;
a fiber optic split sleeve that holds said first and second housings arranged with said gain block situated between said first and second housings;
a first fiber optic coupler that holds said optical pump fiber;
a second fiber optic coupler that holds said autocoupled optical fiber; and
a coupler housing connected to said first and second fiber optic couplers, said coupler housing situating said split sleeve between said first and second fiber optic coupler in alignment so that said pump fiber is aligned with said first ball lens and said reflective end is aligned with said second ball lens.

24. The laser of claim 23 wherein said first and second housings comprise press-fit housings.

25. An autocoupled laser comprising:
a solid state gain medium that defines an emission wavelength;
a first ball lens arranged proximate to a first side of the gain medium to couple said pump source into said gain medium, said first ball lens having a reflective outer surface that reflects said emission wavelength;
an optical pump source arranged for pumping said gain medium through said first ball lens;
a second ball lens arranged proximate to a second side of the gain medium opposite from said first ball lens, said second ball lens substantially transmissive to the emission wavelength;
a single mode optical fiber having a reflective end positioned proximate to the outer surface of said second ball lens; and
a laser cavity comprising
a first end defined by said reflective outer surface of said first ball lens, and
a second end defined by said reflective end of said single mode optical fiber.

26. The laser of claim 25 wherein said optical fiber comprises a Bragg grating inside said optical fiber, thereby providing said reflective end, said Bragg grating also defining a predetermined reflective wavelength.

27. The laser of claim 25 wherein said optical fiber has a core and a cladding surrounding the core, and said reflective end comprises an exposed core and a reflective coating formed on the cladding of said optical fiber surrounding said core, so that laser emission within said laser cavity is hole-coupled into said core of said optical fiber.

28. The laser of claim 25 wherein said optical pump source comprises an optical pump fiber coupled to a source of optical radiation.

29. The laser of claim 28 including a laser assembly that comprises:
a first housing that holds said first ball lens;
a second housing that holds said second ball lens;
a fiber optic split sleeve that holds said first and second housings arranged with said gain block situated between said first and second housings;
a first fiber optic coupler that holds said optical pump fiber;
a second fiber optic coupler that holds said single mode optical fiber; and
a coupler housing connected to said first fiber optic coupler on a one end and connected to the second fiber optic coupler at the other end, said coupler housing situating said split sleeve between said first and second fiber optic coupler in alignment so that said pump fiber is substantially aligned with said first ball lens and said reflective end is substantially aligned with said second ball lens.

30. The laser of claim 29 wherein said first and second housings comprise press-fit housings.
